(19) United States
(12) Patent Application Publication
(10) Pub. No.: US 2006/0224324 A1
(43) Pub. Date: Oct. 5, 2006

(54) METHOD AND SYSTEM FOR CREATING ASTRONOMICAL OBSERVING PLANS FOR AUTOMATED OBSERVATORIES

(76) Inventor: Robert Bruce Denny, Mesa, AZ (US)

Correspondence Address: ROBERT B. DENNY, 6665 E. VANGUARD ST., MESA, AZ, 85215-7737, US

(21) Appl. No.: 11/308,403

(22) Filed: Mar. 22, 2006

Related U.S. Application Data
(60) Provisional application No. 60/594,323, filed on Mar. 29, 2005.

(51) Int. Cl. G06F 19/00

(52) U.S. Cl. 702/2

(57) ABSTRACT

A method and system for creating astronomical observing plans is disclosed. The method provides the observer with a visual means to allocate observing time to multiple astronomical objects when each of said objects are in a favorable sky position for observation. The system uses a separate planetarium program as a visual aid and receives both target selection and varying date/time inputs from the planetarium. Using this list, plus user inputs specifying one or more images to be taken of each target, the system generates a continuous display that indicates the status of the observatory (busy or idle) for the currently selected time in the planetarium. In the preferred embodiment, this status display is fed back to the planetarium, however this is not a requirement. By varying the time in the planetarium, the user can easily select new objects to add to the list at favorable sky positions and times when the observatory is idle. The method thus visually solves the combined problem of target selection and timing. Once the list of selected targets is complete, the system can produce an observing plan document in a format suitable for a plurality of automated observatory control systems.

### FIELD OF THE INVENTION

The present invention relates to astronomy. More particularly, the present invention relates to the preparation of observing instructions (hereinafter called an “observing plan”) for an automated observing system (hereinafter called a “robotic observatory”).

### BACKGROUND OF THE INVENTION

A robotic observatory captures digital images of astronomical objects through the use of a telescope and a digital imager (typically a CCD or CMOS camera) attached to the telescope. A computer and its software controls both the telescope and the imager to steer the telescope, operate the imager, and store the captured digital images on the computer's mass storage system for later post-processing and analysis. The computer may also operate other instruments such as a focuser and a color filter selector for the imager. It may also control the observatory enclosure to provide the telescope and imager with a window on the sky while shielding them from light and/or wind.

Images of an object are best acquired through the least thickness of the atmosphere. As the earth rotates, astronomical objects appear to rise, move across the sky, and set. When a selected astronomical object (hereinafter called a “target”) is at its highest altitude above the horizon (“transit”), it is viewable through the least thickness of the atmosphere. It is common for an observation of a single target to consist of a plurality of images. Acquiring these images of an object takes time, often many minutes or hours. Ideally, then, imaging of an object should start at its transit time minus half of the imaging time, thus bracketing the transit time. In this way, the images of the object are captured through the least thickness of the atmosphere.

The location in the sky of astronomical objects is almost always specified using the equatorial coordinate system. A person skilled in the science of astronomy understands the specifics of this coordinate system. Equatorial coordinates consist of right ascension and declination. An observing plan designates objects by a name and a set of equatorial coordinates. The plan may contain the coordinates, or it may contain only the target's object name. In the latter case, the robotic observatory may consult a database of known objects to retrieve the coordinates of the target.

Once the equatorial coordinates are known, the position of the target in the sky above the observer can be calculated using the geographic location of the observer and the time. The sky position is almost always given in local horizontal coordinates. The calculations and the specifics of the local horizontal coordinate system are well known to a person skilled in the science of astronomy. Local horizontal coordinates consist of azimuth and altitude. Thus, for a given location on the earth, it is possible to calculate the altitude above the horizon of a given astronomical object given a clock time.

Typically, an observation of a single target consists of a plurality of images of the target, often using a plurality of color filters and using varying exposure times for each. Furthermore, each image typically has an exposure time from seconds to minutes. Thus, the totality of time needed to observe one target can span minutes or hours. It is therefore important to consider the elapsed time needed to observe a target as well as the clock time at which observations should start in order to minimize the thickness of atmosphere through which the observation is made.

Robotic observatories are typically expensive, which gives rise to the desire to maximize their use. Ideally, all of the available time on a given night will be used to acquire images. It is undesirable for the observatory to sit idle for any significant period of time. This gives rise to the planning problem, which is a subject of the present invention. Simply stated, the planning problem consists of selecting targets to observe at favorable times and adjusting the imaging time to maximize the use of the robotic observatory. An astronomer must choose targets based on need and/or priority, the times at which their positions are favorable, and adjust the imaging time as needed to get the required data efficiently. This presents the astronomer with a multi-dimensional optimization problem.

In the current art, astronomers commonly use a computer software planetarium program to assist in their visualization of the positions of astronomical objects from their geographic location at varying times of the night. The planetarium program displays a visual representation of the night sky at their geographic location, drawing symbols for astronomical objects at the sky positions at which they may be seen for a given time of day (“time”). As the planetarium's time is varied, the astronomical objects move on the display according to their actual sky positions for that time. Most planetariums provide a means to select targets from the available astronomical objects, and after selection the planetarium makes available for the astronomer descriptive data about the selected target.

The planetarium program is a useful tool; however it does not by itself solve the planning problem. An astronomer may use the planetarium program to see which astronomical objects are “up” at various times. Decisions then must be made as to which targets to observe, how much imaging time to devote to each target, and when to start observing each. Furthermore, observing of a given target may span several nights; partial sets of images may be acquired on a given night with the remainder to be acquired on successive nights. Thus, an astronomer who is planning a particular night's observations is faced with a multi-dimensional planning problem. Since the astronomer may have some latitude in deciding how long to observe which targets on a given night, the problem is compounded.

Once these decisions have been made, an observing plan is then prepared. The observing plan is a set of instructions for the robotic observatory that specify the chosen astronomical targets, and for each target, its equatorial coordinates, the time at which image acquisition is to start, and the specification of the images to be acquired. Furthermore, the specification of each image to be acquired for each target includes the exposure time and color filter to be used, as well as any post-processing that is to be performed on each image or on groups of images. The observing plan may also contain additional instructions for manipulating imager focus, location at which acquired images are to be stored on the computer, and other such additional instructions as needed to accomplish the observing program using the specific robotic observatory being employed.

### SUMMARY OF THE INVENTION

The present invention overcomes the above-identified planning problem and further assists in the preparation of the observing plan. More particularly, the present invention provides the astronomer with a means of collecting target selections from the planetarium, visualizing the timing and time-dependent sky positions of the observations of each target, scheduling observations to make the most efficient use of observing time, adjusting the image specifications to vary the observing time of each target, and preparation of the observing plan document. The system broadly comprises software modules (1) for capturing target selections from the planetarium (“target capturer”), (2) for collecting these selections into a target list (“collector”), (3) for allowing an astronomer to specify the images to be acquired for each target in the target list (“image specifier”), (4) for generating a display which assists the astronomer in determining, as a function of the planetarium time, whether the observatory is actively imaging or is available for additional images (“guide-display generator”), and (5) for creating an observing plan from the data thus collected and specified (“plan generator”).

In typical use, an astronomer first sets the time of the planetarium to the beginning of the night, and then chooses a target that is favorably positioned in the sky above the observatory as depicted at that time on the planetarium display. The target capturer transfers to the collector the name and coordinates of the selected target as well as the planetarium's time of day. The collector receives this information and enters the target into its list. The astronomer next uses the image specifiers to specify the images to be taken of the just-selected target as previously described. This act establishes the total time needed to observe the target. Meanwhile, operating in the background, the guide-display generator continuously scans the collector's target list which contains, among other information, the total time needed to observe each target in the list. Using this information, as well as the planetarium's current time of day, the guide-display generator projects a visible guide-display that indicates one of three possible states:
Time remaining in the current observation
Time until the next observation starts
Remainder of night is free
   As the astronomer varies the planetarium's time of day, the guide-display is continuously updated to reflect the status of the observatory at that time.

Thus, an astronomer would ordinarily next advance the planetarium's time of day until the guide display indicates that the remainder of the night is free. The astronomer now sees the astronomical objects that are in a favorable sky position for the time at which first observation completes. Henceforth, the cycle is repeated: choosing a target, specifying images, and advancing the planetarium time until the guide-display once again reports that the remainder of the night is free. Thus, using the present invention, an astronomer can quickly and easily fill the night with back-to-back observations of targets that are favorably positioned during their observations. Once this repetitive planning process is complete, and the night is filled with observations, the astronomer then uses the plan generator, which automatically reads the target list and it's associated observing start times, target coordinates, and image specifications, to generate the observing plan document in a format suitable for input to the robotic observatory.

It is important to note that the aforementioned strategy of planning from the beginning of the night linearly through to the end is not the only strategy that is supported by the present invention. For example, the astronomer could have a high-priority target to observe that is not in a favorable sky position until late in the night. The astronomer can first advance the planetarium time to put the high-priority target into a favorable position, and using the present invention, select it and specify its images. Then, using the guide-display, the astronomer can move the planetarium time backwards to put other objects into favorable positions earlier in the night. As this is done, the guide display continuously indicates the amount of free time remaining until the observation of the high-priority target is scheduled to commence. Thus, the astronomer knows how much time is available for observing earlier objects and can choose targets and imaging times accordingly. Planning for targets that follow the high-priority target follows the procedure described in the preceding paragraph. Furthermore, the system allows the astronomer to adjust the number of images and their exposure times for any of the targets in the collector's list at any time. The results of such adjustments are immediately reflected in the guide display. By logical extension, it is thus apparent that the present invention supports a variety of observing strategies while still solving the planning problem.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a functional diagram showing the components of the present invention and the flow of data between them, as well as the flow of data between the planetarium and the components of the present invention; and

FIG. 2 is a modular block diagram of the preferred embodiment showing the software modules that comprise the components of the present invention and their partitioning between the planetarium program and a separate program.

FIG. 3 shows the relationship of the elements of the target list and the Observation objects that contain the information about each target.

FIG. 4 shows a typical visual appearance of the combined target collector and image specifier as it appears in the preferred embodiment of the present invention.

FIG. 5 is a flow chart depicting a single pass through the guide-display generator loop.

FIG. 6 is a listing of the object Interface Description Language (IDL) that describes the methods and properties exposed by the combined image specifier and collector server for use by the combined target capturer and guide-display generator client.

### BEST MODE OF CARRYING OUT THE INVENTION

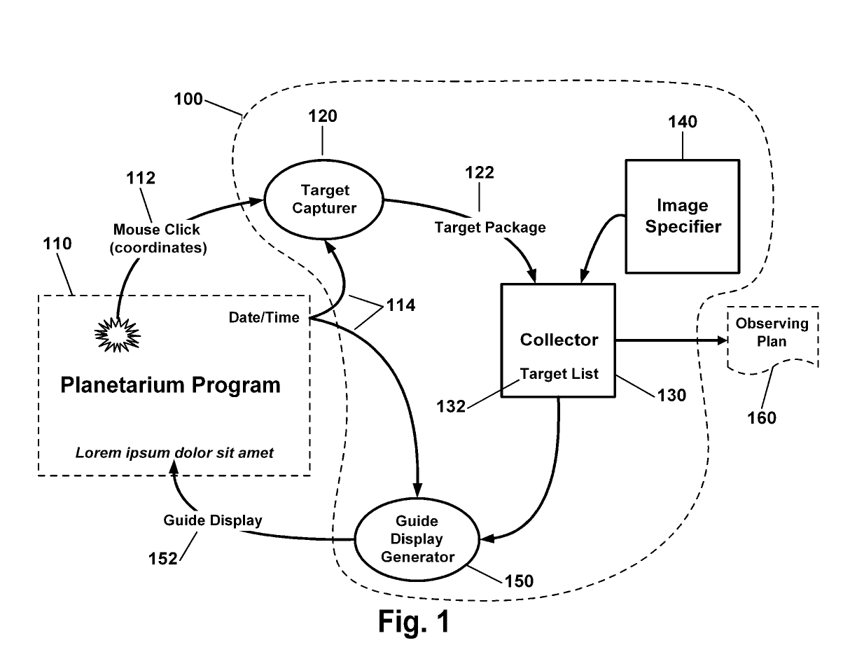

The present invention is preferably implemented entirely in computer software. Referring to FIG. 1, the method is implemented within region 100 as the preferred system, which receives from the planetarium 110 the coordinates 112 of a selected target and the time of the planetarium's current display 114, and which sends to the planetarium continuously updated guide-display message 152 that is derived from a user-supplied set of targets and images to be acquired of each target. Furthermore, on user command the system generates and produces the observing plan 160 and preferably writes the plan 160 to a computer disk file in the format required by the robotic observatory to be used.

In particular, within the system 100, the target capturer 120 receives from the planetarium 110 the coordinates 112 of user-selected targets and the planetarium time 114, and then packages these data items as a target package 122 for transmission to the collector 130. Upon receipt of a target package 122, the collector 130 adds the target package 122 to a target list 132 of such target packages that it may have previously collected from the planetarium 110 via the target capturer 120 as previously described. At any time, the operator of the system (typically the astronomer) may employ the image specifier 140 to either (a) add image specifications to, or (b) adjust the existing image specifications of, any target package 122 in the target list 132. Meanwhile, the guide-display generator 150 continuously monitors the planetarium time 114 and continuously scans the target list 132, as well as the image specifications thereof, to produce its dynamic guide-display. Immediately upon detecting a change in the time of the planetarium 110, additions and deletions to the target list 132, or changes to image specifications of the targets in the target list 132, the guide-display generator 150 alters the guide-display to reflect the changes In allocated observing time. Preferably, the rate at which the guide-display generator 150 updates its display in response to the aforementioned changes shall be high enough to create the illusion of instant response to such change.

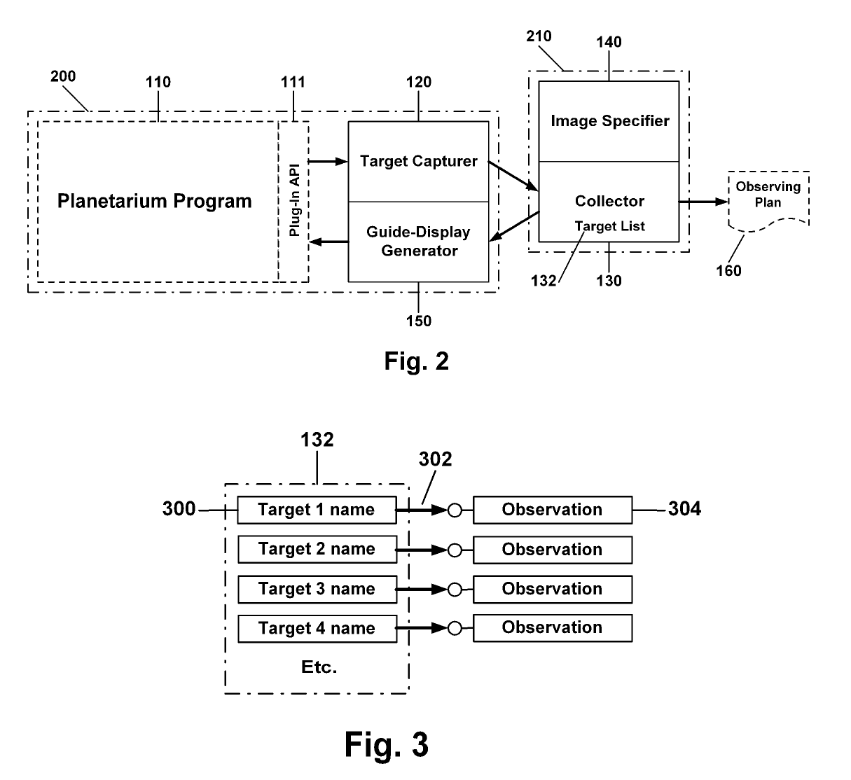

Referring to FIG. 2, the target capturer 120 and guide-display generator 150 actually reside within the program environment of the planetarium 110 as a plug-in. Communications between the target capturer 120 and the planetarium 110 are via an application programming interface (API) 111 provided by the planetarium. Likewise, communications between the guide-display generator 150 and the planetarium 110 are via the API 111. Furthermore, the functions of the target capturer 120 and the guide-display generator 150 are preferably combined within the same plug-in. The region 200 depicts that the planetarium 110, its API 111, the target capturer 120, and the guide-display generator 150 are part of the same executable program on the host computer. The plug in is a software package that is dynamically loaded by the planetarium 110 and thus, while the plug-in is a separately compiled package, it becomes part of the executable program of the planetarium 110 as soon as the planetarium is started. A person with ordinary skills in computer programming will understand the concepts of APIs, plug-ins and dynamically loaded packages.

Furthermore, the collector 130 and the image specifier 140 reside within a single executable program on the host computer (the “planner”), as depicted by the region 210. This is done because the image specifier 140 needs close access to the target packages in the target list 132, as it is responsible for supplying, via user input, the image specifications. Referring to FIG. 3, preferably the target and image specifications are stored in Observation objects 304 that are connected to the elements 300 of the target list 132, where the elements 300 of the list itself contain only the names of the targets. Thus, each element 300 of the target list 132 contains, by reference 302 to the Observation objects 304, not only the target specifications (coordinates and imaging start time) but also the image specifications for each target in the list. Specifically, each Observation object 304 contains the following information for the corresponding target in the list 132:
The equatorial coordinates of the target,
the time at which imaging of the target is to commence,
one or more image sets, each of which consist of (a) the color filter to be used, (b) the exposure interval for each image to be acquired with the specified filter, (c) the requested resolution (“binning”) of each image to be acquired with the specified filter, and (d) the number of images to be acquired with the specified filter, and finally
the estimated total time needed to acquire all image sets contained in the Observation object 304.
   An algorithm that is hidden within each Observation object 304 automatically calculates the estimated total imaging time. Preferably, this time estimate includes not only the sum of the exposure times for each image, but also such overhead times as are needed to make the imaging time estimate as accurate as possible. Examples of overhead times are (a) the time needed to change color filters, (b) the time needed to move the telescope from the previous target to the current target, and (c) the time needed to adjust the focus of the imager and telescope as needed to accommodate color filters with different optical properties. In the preferred embodiment, overhead times are provided by the astronomer via a one-time setup form and made available to the time estimate algorithms in each instance of Observation object 304.

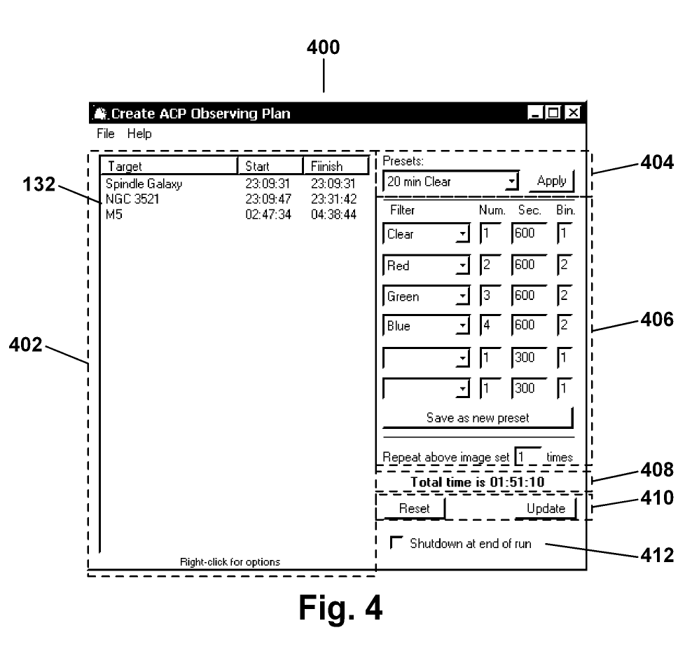

Referring to FIG. 2, the image specifier 140 provides the astronomer with a means for selecting a target in the target list 132 and immediately displays the image sets for the selected target by reading the image set information contained in the Observation object for that target. A graphical user interface (UI) is provided by which the astronomer can add, remove, and change image sets for the selected target. When the astronomer has completed the changes, clicking an update button makes the changes permanent. At this time, the total imaging time estimate for the target is recalculated. The visual appearance of the combined collector and image specifier program 210 is depicted in FIG. 4. The target list 132 is displayed in the region 402; the display includes not only the target name, but also the starting and ending time for image acquisitions of the target. The controls for the image specifier are displayed collectively in the regions 404, 406, and 410. More specifically, region 406 contains the controls for specifying up to six image sets for each of six color filters. Once the desired image sets have been specified, the astronomer clicks the Update button in region 410 to transfer the image set data to the corresponding Observation object. Region 404 contains controls that allow the astronomer to select a previously saved set of image specifications and load them into the image specifier controls in region 406. This is provided only as a convenience, and is not integral to the image selector. Region 408 shows the total time needed for all images to be acquired in the currently selected target in the target list 132, and is updated any time the Update button in region 410 is selected. This total time is the result of aforementioned automatic calculation contained within the corresponding Observation object, and is also used to adjust the ending time for imaging that is displayed in the target list 132 in region 402.

Refer to FIG. 1. A key element of the present invention is the guide-display 152. It is the information provided by the guide-display that enables the astronomer to easily overcome the previously described multi-dimensional planning problem. The guide-display generator 150 continuously monitors the current planetarium time 114 and the target list 132. If a change is detected in either information source, the guide-display is changed to reflect the current condition of the robotic observatory. As described earlier, the guide-display generator should preferably be run at intervals short enough to give the illusion that the guide display is being continuously updated.

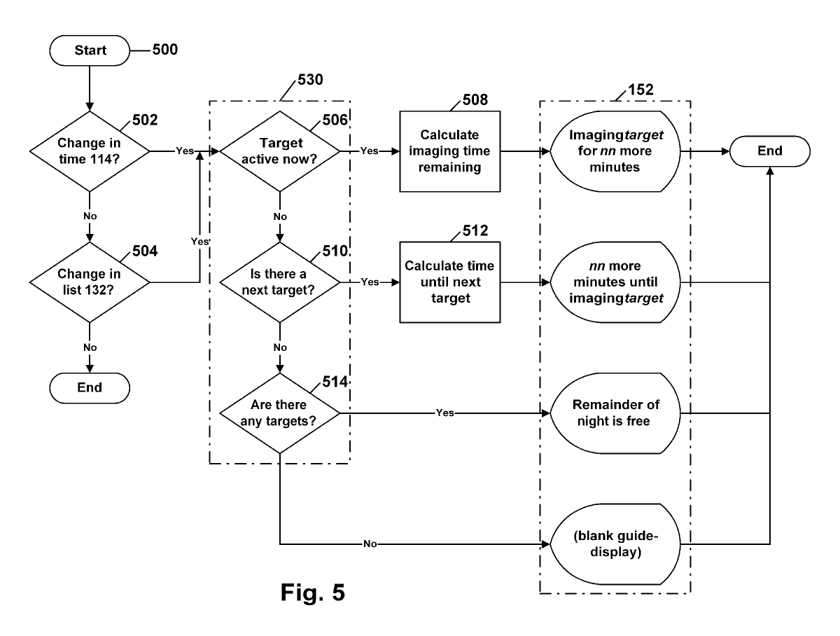

Referring to FIG. 5, the guide display generator is run (entering at block 500) periodically, preferably at intervals of less than one second. The decisions 502 and 504 are not critical to the present invention; they are included in the preferred embodiment simply to prevent needless recalculation of the same guide-display result when no changes in the source information have occurred. If the result of decisions 502 or 504 is yes, the guide-display calculations begin. Region 530 contains decisions that involve access to the target list 132. The first test 506 determines if there is a target in the list 132 whose imaging start time is before the current planetarium time 114 and whose estimated imaging time, when added to its imaging start time, would result in an estimated imaging completion time that is after the current planetarium time 114. If both are true, then the target will be in the process of being acquired at the current planetarium time. In this case, calculation 508 is performed, and the resulting guide-display 152 should preferably be “Imaging target for nn more minutes”, where target is the target name, and nn is the number of minutes remaining until imaging of said target will be completed. If the result of test 506 is false, then test 510 is performed. Test 510 scans the target list 132 to find the target whose imaging start time is closest to and later than the current planetarium time 114. If there is such a target, then the result of test 510 is true. In this case, calculation 512 is performed, and the resulting guide-display should preferably be “nn minutes until imaging target”, where nn is the number of minutes between the current planetarium time 114 and the imaging start time of the target, and target is the name of the target whose imaging is scheduled to start in nn minutes. If the result of test 510 is false, then test 514 is performed. Test 514 scans the target list 132 to determine if there any targets in the list at all. If there are any targets in the list, then the guide-display should preferably be “The remainder of the night is free”, and if not, the guide display should preferably be blank (no display). It is important to note that test 514 is not critical to the operation and use of the present invention; it is instead simply a convenience to the user, and part of the preferred embodiment. In the absence of test 514 and in the case of a false result of test 510, the guide-display would preferably be “The remainder of the night is free”.

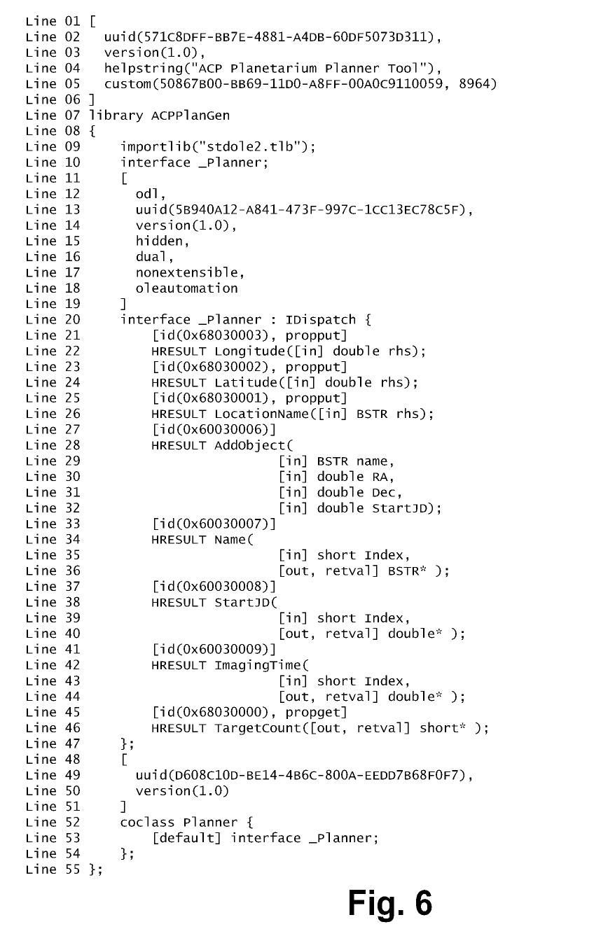

Referring to FIG. 2, the means of communication between the two executable programs depicted by region 200 and region 210 is preferably via the use of the Microsoft Windows Component Object Model (COM), more particularly a subset of COM, variously called Automation or ActiveX. Other inter-process communication means may be used, however, without deviating from the intent of the present invention. Preferably, the combined target capturer 120 and guide-display generator 150, (implemented as a planetarium plug-in as previously described), is an ActiveX client, and the combined collector 130 and image specifier 140 (the planner), implemented as a separate program as previously described, is an ActiveX server. FIG. 6 is a view showing the Interface Definition Language (IDL) that describes the methods and properties exposed by the planner as its ActiveX object interface. The ActiveX methods and properties exposed by the planner (its “interface”) are available for use by any Windows program, however their specificity is such that the interface is primarily useful to the plug-in. The meaning of an IDL representation of an ActiveX server's interface is known to persons with ordinary skill in Windows ActiveX programming.

Continuing with FIG. 6, the specifics of the planner's ActiveX server capabilities are embodied in lines 21 through 47. Lines 21 through 26 provide the ability of the client to send to the server the planetarium's present geographic Latitude and Longitude, as well as a name for the planetarium's present location. The planner uses this when generating the observing plan to describe the location for which the plan was prepared. Lines 28 through 32 describe the function call of the ActiveX object that are used by the target capturer to add a target to the collector's target list. As can be seen in the listing, the parameters of the AddObject function are the target's name, its equatorial coordinates and its desired imaging start time (as a Julian date). Lines 33 through 46 describe functions of the ActiveX object that are used by the guide-display generator. The TargetCount property described in lines 45 and 46 is used to retrieve the total number of targets in the target list. Once known, the functions described in lines 33 through 44 are used to obtain information about a specific target that is contained in a numbered element of the target list. The Name, StartJD and ImagingTime functions each take an Index parameter that specifies the position in the target list about which the returned information should apply. This, the interface elements described in lines 33 through 46 provide all of the information needed for the guide-display generator to function as described in FIG. 5.

Although the preferred embodiments and drawings of the present invention have been disclosed for illustrative purposes, those skilled in the art appreciate that that various substitutions, modifications, changes, and additions are possible without departing from the scope and spirit of the invention.

According to the present invention described above, it is possible to use a planetarium program in combination with the invention to easily overcome the problems that are commonly encountered by astronomers when planning a night's observations. Specifically, the present invention greatly eases the combined tasks of scheduling observations of astronomical objects at favorable times and keeping the robotic observatory as busy as possible while doing such observations.

What is claimed is:

1. A method and system for creating astronomical observing plans for automated observatories, the system comprising
capturing an astronomical target's coordinates and observing time of day from a planetarium software program;
collecting each thus captured target's coordinates and observing time of day into a list;
specifying, for each thus captured target, a set of one or more images to be acquired, to include, for each image, the exposure starting time of day, the total elapsed time needed for exposures and other observing overhead, and (optionally) a color filter to be used;
calculating the total elapsed time needed for the specified images of each specified target, including observatory overhead time;
using the plurality of this information to display the activity status of the observatory at any particular time of day; and
using the plurality of this information to generate a set of instructions for a robotic observatory allowing it to acquire, starting at the specified time, the specified images of each specified target.

2. The system according to claim 1, wherein the plurality of means, typically embodied by (but not limited to) software program modules, provides a solution to the problem of choosing targets by their coordinates and observation time of day, such that the observatory may be used to its fullest capacity.

3. The method according to claim 1, wherein the plurality of program modules comprise component modules which are operable to establish communication with the astronomer via a user interface, calculation modules comprising a plurality of component modules, and object communication modules which do not include the user interface and which receive requests from the planetarium via transfer modules.

4. The method according to claim 1, further comprising providing for user input and specification of non-imaging time estimates (observatory overhead time), including but not limited to the time needed to move the telescope to the present target, additional time needed to achieve mechanical stability of the telescope after such move, the time needed to transmit image data from the camera to the controlling computer, and post-acquisition image processing.

5. The method according to claim 4, further comprising, using the time estimates addition to the actual imaging time to calculate the total elapsed time to acquire each image in the list.

6. The methods of claims 4 and 5, further comprising, using said total elapsed acquisition time, along with the varying planetarium time of day, to determine the varying observatory status conditions of (a) busy, (b) elapsed time remaining until the next observation, or (c) nothing scheduled in the future, and continuously displaying said observatory status, thus informing the astronomer as to the varying observatory status condition at the selected planetarium time of day.

7. The method of claim 1, further comprising, using the list of targets, their coordinates, image counts, exposure times, and optionally color filters, plus the specified start times, to produce an observing plan suitable for use by a robotic observatory. Nothing in this claim shall specify a particular syntax or format of said observing plan; any format or syntax is claimed as long as it is produced using the means of the preceding claims 1-6.
